(19) United States
(12) Patent Application Publication
(10) Pub. No.: US 2006/0053137 A1
(43) Pub. Date: Mar. 9, 2006

(54) Two-dimensional code information handling device

(75) Inventor: Yoshifumi Tanimoto, Osaka (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKIA KAISHA

(21) Appl. No.: 11/200,953

(22) Filed: Aug. 10, 2005

(30) Foreign Application Priority Data
Sep. 9, 2004 (JP) 2004-261837
Sep. 9, 2004 (JP) 2004-261843
Sep. 9, 2004 (JP) 2004-261846

(51) Int. Cl. G06F 17/30

(52) U.S. Cl. 707/101

(57) ABSTRACT

A document management device includes a conversion unit, which converts character information indicating an attribute of document data into two-dimensional code information of a prescribed format, an image data generation unit, which generates image data including the document data and the two-dimensional code information, and an output unit, which outputs the image data.

### BACKGROUND OF THE INVENTION

1. Field of the Invention

The present invention relates to a device, which handles two-dimensional code information, such as a document management device, a facsimile machine and a network facsimile machine.

2. Description of Related Art

Recently, two-dimensional code information having information in two-dimensional directions of a horizontal direction and a vertical direction is becoming widespread. Compared with a one-dimensional code, a two-dimensional code can handle a large volume of information. Therefore, the two-dimensional code can be provided with various pieces of information.

When a conventional printer device prints out print data requested by a terminal device, the printer device prints out a bar code, which includes information for distinguishing the print data and information for distinguishing a printing state, along with the print data. Further, the bar code is printed in an upper end part and a lower end part of paper. The printer device distinguishes the printing state by scanning the bar code at a paper outlet, and manages the distinguished printing state as a print history. In the conventional printer device, a bar code reader is provided at the paper outlet. By scanning the bar code at the paper outlet, the conventional printer device can distinguish the printing state and notify a user that the paper has been discharged.

For example, a Multi-Function Peripheral (MFP), which includes a plurality of functions such as a facsimile transmitting and receiving function, a printer function, a copying function and a scanner function in one machine, and a facsimile machine or a scanner device, which includes either one of the above-mentioned functions, can scan two-dimensional code information printed on a paper medium or the like by using the scanner function. Moreover, the MFP, the facsimile machine and the scanner device or the like can print two-dimensional code information on a paper medium or the like by using the printer function. Therefore, in such a MFP, the two-dimensional code information can be handled easily without additionally providing a special device.

### SUMMARY OF THE INVENTION

An advantage of the present invention is to provide technology for facilitating a management of a document.

According to an aspect of the present invention, a document management device includes a conversion unit, an image data generation unit and an output unit. The conversion unit converts character information indicating an attribute of document data into two-dimension code information of a prescribed format. The image data generation unit generates image data including the document data and the two-dimensional code information. The output unit outputs the image data.

For example, the attribute includes a name of a person who created the document data, an instruction of a processing for the document data, a date and time of the processing and a deadline for processing the document data, a name of a person in charge of the processing for the document data, an acquired date of the document data, transmission destination information of the document data, transmitter information of the document data, a processing result of the document data, and information indicating a feature of the document. The attribute can also include a comment or a postscript for the document data. Although a user can input attribute information, the attribute information can be extracted in accordance with header information or the like included in the document data.

Accordingly, by scanning a printed original document and decoding two-dimensional code information later, information indicating the attribute of the document data can be acquired in a form of character information. Moreover, when the two-dimensional code information is used, a large volume of information can be included in a small area. Therefore, the two-dimensional code information can be included in a predetermined position such as a margin of the document data, and the document data and the two-dimensional code information can be printed out as an original document of one page. As a result, without using an extra sheet of paper, a management of a document can be carried out easily.

The document management device of the present invention can further include an input accepting unit, which accepts an input of character information indicating an attribute of document data. The conversion unit can convert the input character information accepted by the input accepting unit into two-dimensional code information of a prescribed format.

The input accepting unit can also accept an input of character information from an operation unit, such as an operation panel, of the document management device. The input accepting unit can also accept an input of character information from another terminal connected to the document management device via a network.

When printing out the document data, information indicating the attribute of the document data is converted into two-dimensional code information and printed out together with the document data. As a result, by scanning and decoding the two-dimensional code information later, the information indicating the attribute can be acquired in a form of the character information. Accordingly, the management of the document can be carried out easily.

The document management device of the present invention can further include a storage unit, which stores the character information indicating the attribute of the document data by associating with the document data. The conversion unit can convert the character information associated with the document data into two-dimensional code information of a prescribed format.

For example, a work flow or the like of document data can be stored as attribute information by being associated with the document data. When printing out the document data, the attribute information such as the work flow can be converted into two-dimensional code information and printed out.

The document management device of the present invention can further include an instruction accepting unit. The instruction accepting unit accepts an output instruction of document data, and accepts a selection of an attribute to be included in two-dimensional code information of a prescribed format from the attribute stored by being associated with the document data. The conversion unit can convert character information indicating the attribute accepted by the instruction accepting unit into two-dimensional code information of a prescribed format.

When printing out document data, the user can select attribute information to be included in two-dimensional code information, which is to be printed out along with the document data. The user can make the selection from the operation panel of the document management device or from another terminal connected to the document management device via the network or the like.

The document management device of the present invention can further include a setting storage unit, which stores a setting of an attribute to be included in two-dimensional code information of a prescribed format. The conversion unit can refer to the setting storage unit, select an attribute to be included in two-dimensional code information of a prescribed format, and convert character information indicating the attribute into two-dimensional code information of a prescribed format.

Information indicating a document type of document data can be associated with the document data. The setting storage unit can store the setting of the attribute to be included in the two-dimensional code information of the prescribed format for each document type. Accordingly, when the user previously sets a predetermined attribute, two-dimensional code information including the predetermined attribute can be printed out along with document data.

The document management device of the present invention can further include an event storage unit, which stores character information indicating an event to be a trigger for outputting document data. When an event generates, the conversion unit can convert the character information indicating the event into two-dimensional code information of a prescribed format as character information indicating an attribute of the document data.

Also in this case, information indicating a document type of document data can be associated with the document data. The event storage unit can store a setting of an event to be a trigger for outputting document data for each document type. For example, the event is an expiration of a deadline for saving, an end of a processing or an error of the processing. Accordingly, when printing out the document data, two-dimensional code information indicating an event that triggered the document data to be printed is also printed out along with the document data. As a result, a processing generated with respect to the document data can be grasped. The character information before being converted can also be printed out along with the two-dimensional code information. Accordingly, in accordance with the character information indicating the event, the user can grasp the generation of the event. In addition, the user can carry out a document management by using the two-dimensional code information.

In the document management device of the present invention, the output unit can output the two-dimensional code information converted by the conversion unit along with the attribute information indicated by the character information before being converted.

Accordingly, the management of the document data can be carried out easily by using the two-dimensional code information, and the user can grasp a content of the two-dimensional code information. As a result, convenience improves.

According to another aspect of the present invention, a facsimile machine includes a reception unit, a conversion unit and a printer unit. The reception unit receives facsimile data. The conversion unit converts communication information relating to the facsimile data received by the reception unit into two-dimensional code information of a prescribed format. The printer unit simultaneously prints out the facsimile data received by the receiving unit and the two-dimensional code information of the communication information relating to the facsimile data.

For example, the two-dimensional code information of the prescribed format is a Quick Response (QR) code.

The facsimile data and the two-dimensional code information can be printed out onto same paper or sequentially printed out onto separate papers.

As described above, by printing out the two-dimensional code information indicating the communication information relating to the facsimile data along with the facsimile data, a part of the two-dimensional code information printed on a paper medium can be decoded and converted into character information later. As a result, the communication information relating to the facsimile data can be acquired in a form of character information. Accordingly, the management of the facsimile data can be carried out easily.

The facsimile machine of the present invention can further include an image data generation unit, which generates image data including the facsimile data received by the reception unit and the two-dimensional code information of the communication information relating to the facsimile data. The printer unit can print out the image data.

The two-dimensional code information can include a large volume of information in a small area. Therefore, the image data can be generated by including the two-dimensional code information in a margin of the facsimile data. By printing out such image data, the communication information relating to the facsimile data can be printed out onto the same paper as the facsimile data without using an extra sheet of paper.

In the above-described facsimile machine, the reception unit can receive the communication information relating to the facsimile data as header information indicated by character information, and the conversion unit can convert the header information into two-dimensional code information.

For example, the header information includes a name of a transmitter, a telephone number of the transmitter and a date and time of reception. By converting such header information into the two-dimensional code information, a part of the two-dimensional code information printed on a paper medium can be decoded and converted into character information later. As a result, the header information can be acquired in a form of the character information. Accordingly, a management of the facsimile data can be carried out easily.

The facsimile machine of the present invention can further include an instruction accepting unit and a transmission unit. The instruction accepting unit accepts a transmission instruction of facsimile data. The transmission unit transmits the facsimile data in accordance with the transmission instruction of the facsimile data accepted by the instruction accepting unit. The conversion unit can convert communication information relating to the facsimile data, which the transmission instruction has been accepted by the instruction accepting unit, into the two-dimensional code information of the prescribed format. The printer unit can simultaneously print out the facsimile data, which the transmission instruction has been accepted by the instruction accepting unit, and the two-dimensional code information of the communication information relating to the facsimile data.

According to another aspect of the present invention, a facsimile machine includes an instruction accepting unit, a transmission unit, a conversion unit and a printer unit. The instruction accepting unit accepts a transmission instruction of facsimile data. The transmission unit transmits the facsimile data in accordance with the transmission instruction of the facsimile data accepted by the instruction accepting unit. The conversion unit converts communication information relating to facsimile data, which the transmission instruction has been accepted by the instruction accepting unit, into two-dimensional code information of a prescribed format. The printer unit simultaneously prints out at least a part of the facsimile data, which the transmission instruction has been accepted by the instruction accepting unit, and the two-dimensional code information of the communication information relating to the facsimile data.

For example, the communication information relating to the facsimile data includes a name of a transmission destination, a telephone number or the like of the transmission destination, a date and time of a transmission and a transmission result or the like. The entire facsimile data can be printed out, or only a part of the facsimile data can be printed out. The facsimile data and the two-dimensional code information can be printed out onto the same paper or sequentially printed out onto separate papers.

By converting the communication information into the two-dimensional code information, a part of the two-dimensional code information printed on a paper medium can be decoded and converted into character information later. Since the communication information can be acquired in a form of the character information, the management of the facsimile data can be carried out easily.

The facsimile machine of the present invention can further include an image data generation unit, which generates image data including at least a part of the facsimile data, which the transmission instruction has been accepted by the instruction accepting unit, and the two-dimensional code information of the communication information relating to the facsimile data. The printer unit can print out the image data.

Since the two-dimensional code information can include a large volume of information in a small area, the image data can be generated by including the two-dimensional code information in a margin of the facsimile data. By printing out such image data, without wasting an extra sheet of paper, the communication information relating to the facsimile data can be printed out along with the facsimile data.

In the facsimile machine of the present invention, the conversion unit can convert the transmission instruction accepted by the instruction accepting unit into two-dimensional code information as the communication information relating to the facsimile data.

For example, the transmission instruction is a name of a transmission destination, a telephone number of the transmission destination, a scheduled date and time of a transmission, and a number of times for retrying the transmission. By printing out such a transmission instruction along with the facsimile data, for example, when the facsimile data fails to be transmitted due to an error, the two-dimensional code information can be decoded and a content of the transmission instruction can be acquired in a form of character information. Accordingly, the acquired character information can be used for determining whether to repeat the same processing or whether to transmit the facsimile data again. As a result, the management of the facsimile data can be carried out easily.

The facsimile machine of the present invention can further include a transmission result acquiring unit, which acquires a transmission result of the facsimile data transmitted by the transmission unit. The conversion unit can convert the transmission result acquired by the transmission result acquiring unit into two-dimensional code information as the communication information relating to the facsimile data.

For example, the facsimile machine can add error information or the like as two-dimensional code information to an original document where the transmission error has occurred. The facsimile machine can also add transmission information, such as a date and time of a transmission and destination information, as two-dimensional code information to the transmitted original document. Accordingly, by scanning and decoding the two-dimensional code information, a determination can be made as to a processing carried out on the original document.

The facsimile machine of the present invention can further include a decoding unit, which decodes two-dimensional code information of a prescribed format. The instruction accepting unit can accept the transmission instruction of the facsimile data in a form of the two-dimensional code information of the prescribed format. The transmission unit can transmit the facsimile data in accordance with the transmission instruction decoded by the decoding unit.

For example, the transmission instruction is a name of a transmission destination, a telephone number of the transmission destination, a scheduled date and time of a transmission and a number of times for retrying the transmission. Accordingly, when retransmitting an original document where a transmission error has occurred, a transmission setting of facsimile data can be carried out without selecting and inputting the name of the transmission destination, the telephone number of the transmission destination, the scheduled date and time of the transmission and the number of times for retrying the transmission or the like from the operation unit of the facsimile machine again.

According to another aspect of the present invention, a network facsimile machine includes a reception unit, a conversion unit and a printer unit. The reception unit receives electronic mail including an attached file. The conversion unit converts at least a part of character information of the electronic mail other than the attached file into two-dimensional code information of a prescribed format. The printer unit prints out at least a part of the attached file along with the two-dimensional code information converted by the conversion unit.

For example, the two-dimensional code information of the prescribed format is a QR code. For example, the attached file is image data of the Tagged Image File Format (TIFF) or the Portable Document Format (PDF).

Accordingly, character information relating to the attached file can be printed out in a form of two-dimensional code information along with the attached file. Therefore, a part of the two-dimensional code information of the printed original document can be decoded and converted into character information later. Even after the attached file is printed out, the attached file and the character information can be associated with one another. Accordingly, a management of the data acquired by the network facsimile machine can be carried out easily.

In the network facsimile machine of the present invention, the conversion unit can convert header information of the electronic mail into the two-dimensional code information of the prescribed format.

For example, the header information includes a mail address of a transmitter, a mail address of a recipient, a date and time of a transmission and a broadcast mail address. By converting such header information into two-dimensional code information, a part of the two-dimensional code information printed on a paper medium can be decoded and converted into character information later. Since the header information can be acquired in the form of the character information, even after the attached file is printed out, a management of the original document can be carried out easily.

Accordingly, even after the attached file is printed out, the attached file and the header information of the electronic mail can be associated with one another. Since the two-dimensional code information can include a large volume of information in a small area, when printing out the attached file, the two-dimensional code information can be printed out by being included in a margin of the attached file. Accordingly, the attached file and the header information can be printed out onto the same paper without using an extra sheet of paper for printing out the header information.

In the network facsimile machine of the present invention, the conversion unit can convert main body information of the electronic mail into two-dimensional code information of the prescribed format.

For example, the main body information is text data written in the electronic mail. In general, a network facsimile machine transmits and receives an essential part of facsimile data in a form of an attached file, and just a finite clause or a simple comment is written in a main body of the electronic mail. When such main body information of the electronic mail is printed out independently, an extra sheet of paper is required for printing out the main body information and a paper resource is wasted. However, according to the present invention, since the main body information of the electronic mail is converted into two-dimensional code information and printed out along with the attached file, a number of wasted sheets of paper can be reduced. In addition, a management of the attached file can be carried out easily.

The network facsimile machine of the present invention can further include an image data generation unit, which generates image data including at least a part of the attached file and two-dimensional code information converted by the conversion unit. The printer unit can print out the image data.

The image data generation unit can embed two-dimensional code information in a margin of the attached file. Alternatively, the image data generation unit can reduce a size of a first page of the attached file, and embed two-dimensional code information in a margin of the first page of the attached file. Accordingly, information of the attached file can be printed out, and the two-dimensional code information is printed out onto the same paper. As a result, a paper resource can be saved.

The network facsimile machine of the present invention can further include a determination unit, which determines whether or not the attached file can be printed out by the printer unit. When the determination unit determines that the printer unit cannot print out the attached file, the conversion unit can convert information indicating that the attached file cannot be printed out into two-dimensional code information of the prescribed format along with at least a part of the character information of the electronic mail other than the attached file. The printer unit can print out the two-dimensional code information.

According to the present invention, when a format of the received attached file is unclear and the attached file cannot be opened nor printed out, or when the attached file cannot be printed out due to some other reasons, the network facsimile machine can add error message information or the like in a form of two-dimensional code information. Accordingly, the user can grasp that the network facsimile machine received electronic mail, and a processing for the received electronic mail can be carried out.

Further, any combinations of the above-described constituent elements and conversions of the expression of the present invention between a method, a device, a system, a recording medium, a computer program or the like are also effective as an embodiment of the present invention.

### BRIEF DESCRIPTION OF THE SEVERAL VIEWS OF THE DRAWINGS

FIG. 1 is a block diagram showing a document management device according to a first embodiment of the present invention.

FIG. 2 shows an example of an inner configuration of a setting storage unit.

FIG. 3 is a flowchart showing an example of a processing procedure of the document management device according to the first embodiment of the present invention.

FIG. 4 shows an example of image data printed out by a printer unit.

FIG. 5 is a block diagram showing a configuration of a facsimile machine according to a second embodiment of the present invention.

FIG. 6 is a flowchart showing an example of a processing procedure of the facsimile machine according to the second embodiment of the present invention.

FIG. 7 is a flowchart showing another example of a processing procedure of the facsimile machine according to the second embodiment of the present invention.

FIG. 8 shows a state in which an original document including facsimile data and two-dimensional code information is printed out in the processing procedure shown in FIG. 7.

FIG. 9 is a block diagram showing a configuration of a facsimile machine according to a third embodiment of the present invention.

FIG. 10 is a flowchart showing an example of a processing procedure of the facsimile machine according to the third embodiment of the present invention.

FIG. 11 shows a state in which an original document including an attached file and two-dimensional code information is printed out in the processing procedure shown in FIG. 10.

### DETAILED DESCRIPTION OF THE INVENTION

Embodiments of the present invention will be described. Further, embodiments described below are preferable specific examples for implementing the present invention. Therefore, various technical limitations are made in the description. However, unless explicitly stated in the following description to limit the present invention, the present invention shall not be limited to the embodiments.

A first embodiment of the present invention will be described. A document management device according to the first embodiment includes a function for converting data indicated by character information into two-dimensional code information. Various pieces of information generally known as two-dimensional code information can be used as the two-dimensional code information. For example, a QR code can be used as the two-dimensional code information.

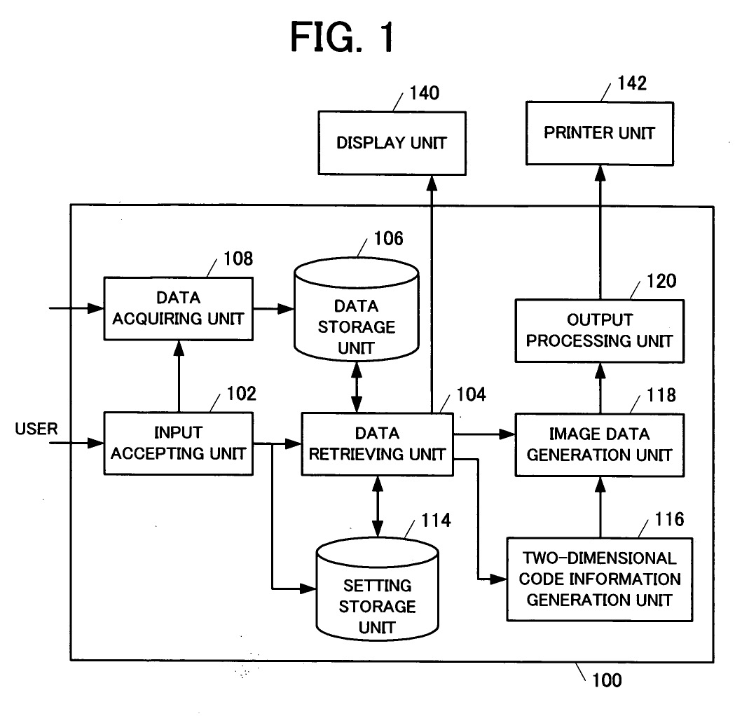

FIG. 1 is a block diagram showing a configuration of a document management device 100 according to a first embodiment of the present invention. The document management unit 100 includes an input accepting unit 102, a data retrieving unit 104, a data storage unit 106, a data acquiring unit 108, a setting storage unit 114, a two-dimensional code information generation unit 116, an image data generation unit 118 and an output processing unit 120.

Each constituent element of the document management device 100 is realized primarily by a Central Processing Unit (CPU) of any computer, a memory, a program which realizes the constituent elements shown in FIG. 1 loaded to the memory, a storage unit such as a hard disk drive which stores the program, and an interface for establishing a connection with a network, by any combination of hardware and software. It is understood by those skilled in the art that various changes and modifications can be made for methods and devices for realizing each of the constituent elements of the document management device 100. Each of the drawings to be described hereinafter shows blocks representing units of function, instead of units of hardware. Further, in FIG. 1, a configuration of a part unrelated to the subject matter of the present invention is omitted.

The input accepting unit 102 accepts various instructions from a user. The input accepting unit 102 also accepts an input of document data from the user, or accepts an input of character information indicating an attribute of the document data. For example, the attribute includes a name of a person who created the document data, an instruction of a processing for the document data, a date and time of the processing for the document data, a deadline for processing the document data, a name of a person in charge of the processing for the document data, an acquired date of the document data, transmission destination information of the document data, transmitter information of the document data, and a processing result of the document data. The attribute can also include a comment or a postscript for the document data. Although the user can input attribute information, the attribute information can be extracted in accordance with header information or the like included in the document data.

The data acquiring unit 108 acquires document data from another terminal via a network (not shown) or by an input made by the user via the input accepting unit 102. The data acquiring unit 108 stores the acquired document data into the data storage unit 106. The data acquiring unit 108 stores a type or an attribute of the acquired document data into the data storage unit 106 along with the acquired document data by associating with the acquired document data.

For example, when the data acquiring unit 108 receives document data via the network, the data acquiring unit 108 stores a document of the received document data as a received document into the data storage unit 106. In addition, the data storage unit 106 stores an attribute of the document data by associating with the document data. For example, the attribute includes a transmitter number, a date and time of a reception, a reception result and a deadline for saving the document data.

For example, when the input accepting unit 102 accepts an input of document data from the user, the input accepting unit 102 can also accept an input of an attribute from the user. For example, the attribute includes a name of the user, a document type, an instruction of a processing for the document data, a name of a person in charge of the processing for the document data and a deadline for saving the document data. The data acquiring unit 108 stores the attribute of the document data accepted by the input accepting unit 102 into the data storage unit 106 by associating with the document data.

The data storage unit 106 stores the document data acquired by the data acquiring unit 108. The data storage unit 106 can also store character information indicating the attribute of the document data by associating with the document data.

The data retrieving unit 104 retrieves document data from the data storage unit 106. In accordance with the instruction of the user accepted by the input accepting unit 102, the data retrieving unit 104 can retrieve corresponding document data from the data storage unit 106. When an attribute such as a deadline for saving the document data is associated with the document data, the data retrieving unit 104 can refer to the data storage unit 106 and retrieve the document data, which the deadline for saving has expired, from the data storage unit 106. When the character information indicating the attribute is stored by being associated with the document data, the data retrieving unit 104 also retrieves the character information according to necessity.

The setting storage unit 114 stores a setting of the attribute to be included in two-dimensional code information. The data retrieving unit 104 refers to the setting storage unit 114, and extracts an attribute to be included in the two-dimensional code information from the document data or the character information associated with the document data retrieved by the data retrieving unit 104.

The two-dimensional code information generation unit 116 converts character information into two-dimensional code information. In the first embodiment, the two-dimensional code information generation unit 116 converts character information indicating the attribute of the document data extracted by the data retrieving unit 104 into two-dimensional code information.

The image data generation unit 118 generates image data by including the two-dimensional code information converted by the two-dimensional code information generation unit 116 into a part of the document data.

The output processing unit 120 carries out a processing for outputting the image data generated by the image data generation unit 118. In the first embodiment, the output processing unit 120 carries out a processing for printing out the image data by a printer unit 142.

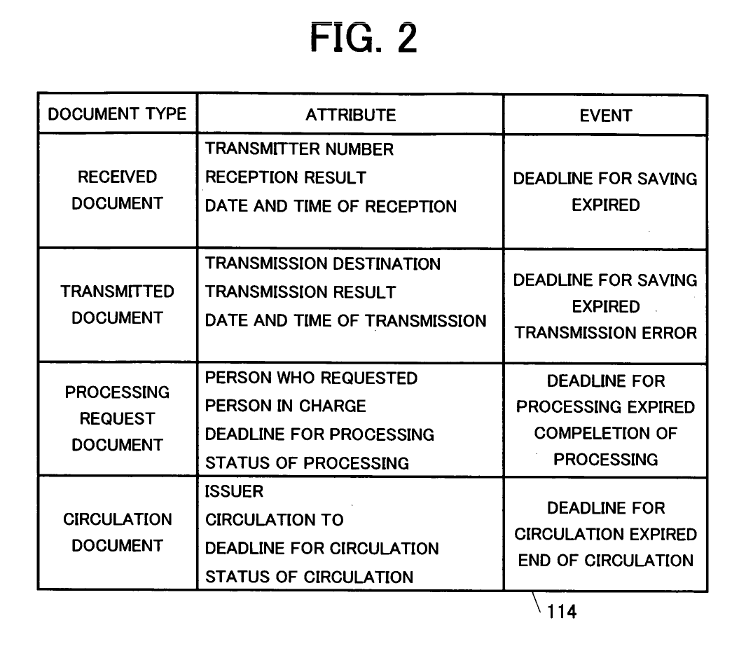

FIG. 2 shows an example of an inner configuration of the setting storage unit 114. The setting storage unit 114 includes a document type column, an attribute column and an event column. The document type column stores a document type. In the example shown in FIG. 2, the document type column stores a “received document”, a “transmitted document”, a “processing request document” and a “circulation document”. In the attribute column, an attribute to be included in two-dimensional code information is stored by being associated with each document type. For example, when a document is the “received document”, a “transmitter number”, a “reception result” and a “date and time of reception” are stored as the attribute to be included in the two-dimensional code information. In the event column, an event to be a trigger for printing out the document data is stored by being associated with each document type. For example, when a document is the “received document”, “deadline for saving expired” is stored as an event to be the trigger for printing.

Referring to FIG. 1 again, when the data retrieving unit 104 retrieves document data from the data storage unit 106 according to a generation of an event, such as an expiration of the deadline for saving, the data retrieving unit 104 also extracts information indicating the event as attribute information to be included in a two-dimensional code.

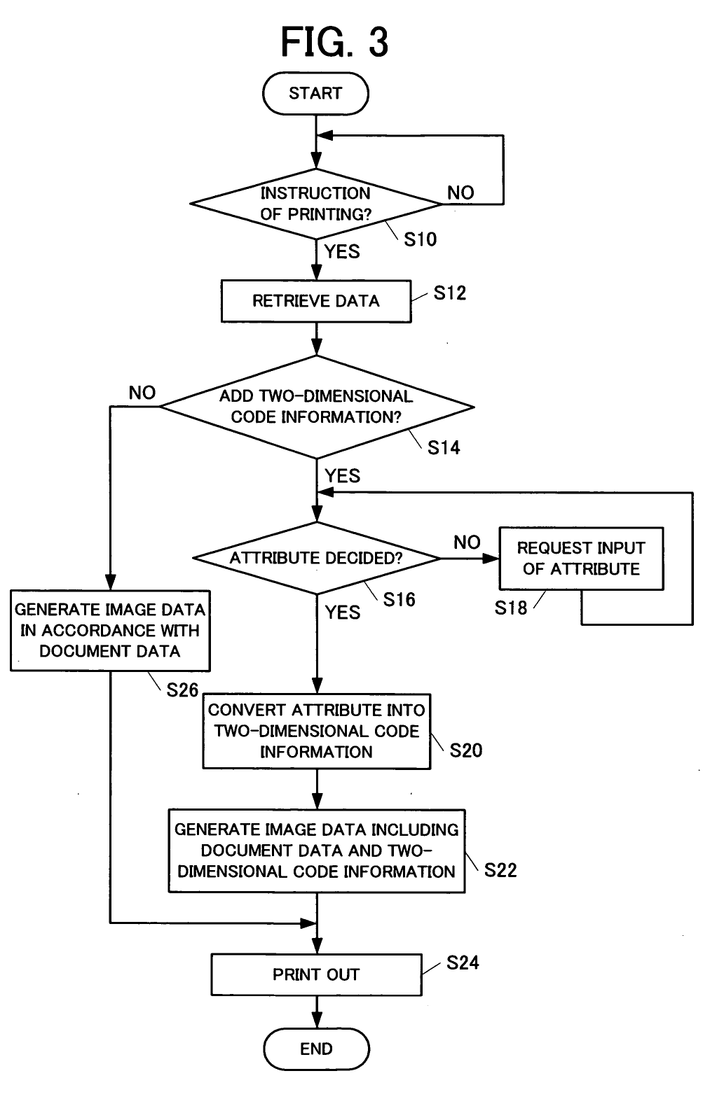

FIG. 3 is a flowchart showing an example of a processing procedure of the document management device 100 according to the first embodiment of the present invention.

When the user instructs to print out document data or when an instruction is made to print out document data as a result of a generation of an event, such as the expiration of the deadline for saving (step S10: YES), the data retrieving unit 104 retrieves corresponding document data from the data storage unit 106 (step S12). In this case, when character information indicating an attribute is associated with the document data, the data retrieving unit 104 also retrieves the character information.

When printing out the document data, the data retrieving unit 104 determines whether or not to add the two-dimensional code information (step S14). For example, the data retrieving unit 104 refers to the setting storage unit 114 in accordance with a type of the document data, and determines whether or not to add the two-dimensional code information. An instruction regarding whether or not to add the two-dimensional code information can be accepted from the user in advance, and stored in the data storage unit 106 by associating with the document data.

When adding the two-dimensional code information (step S14: YES), the data retrieving unit 104 refers to the setting storage unit 114, and determines whether or not character information indicating an attribute, which is to be converted into the two-dimensional code information, has been decided (step S16). When the setting storage unit 114 stores an attribute to be converted into the two-dimensional code information, the data retrieving unit 104 extracts the attribute stored in the setting storage unit 114. Meanwhile, when character information indicating an attribute, which is to be converted into the two-dimensional code information, has not been decided (step S16: NO), the data retrieving unit 104 displays the document data on a display unit 140 along with a message such as “Please input an attribute to be converted into two-dimensional code information”, and requests the user to input the attribute (step S18). The data retrieving unit 104 can accept an input of character information indicating an attribute from the user via the input accepting unit 102. In accordance with the input made by the user, the data retrieving unit 104 extracts the attribute to be converted into the two-dimensional code information.

When the attribute is decided at step S16 (step S16: YES), the two-dimensional code information generation unit 116 converts the character information indicating the attribute into two-dimensional code information (step S20). The image data generation unit 118 generates image data including the document data and the two-dimensional code information (step S22). The output processing unit 120 makes the printer unit 142 to print out the image data generated by the image data generation unit 118 (step S24).

When a determination is made at step S14 not to add the two-dimensional code information (step S14: NO), the image data generation unit 118 generates image data in accordance with the document data (step S26).

Next, referring to FIG. 2, one example of the first embodiment of the present invention will be described. For example, when the data retrieving unit 104 retrieves document data from the data storage unit 106 in accordance with an instruction of the user or due to a generation of an event, the data retrieving unit 104 refers to the setting storage unit 114 and extracts an attribute to be included in two-dimensional code information in accordance with a type of the document data. In the example shown in FIG. 2, for example, when the document data is a received document, a “transmitter number”, a “reception result” and a “date and time of reception” are stored as the attribute. The data retrieving unit 104 extracts the “transmitter number”, the “reception result” and the “date and time of reception” from the retrieved attribute information, and transmits to the two-dimensional code information generation unit 116. When the data retrieving unit 104 retrieves document data from the data storage unit 106 due to a generation of an event, such as a “deadline for saving expired”, the data retrieving unit 104 also transmits character information indicating the generated event to the two-dimensional code information generation unit 116 as the attribute information. The two-dimensional code information generation unit 116 converts the attribute information transmitted from the data retrieving unit 104 into two-dimensional code information. Next, the image data generation unit 118 generates image data including the document data retrieved by the data retrieving unit 104 and the two-dimensional code information converted by the two-dimensional code information generation unit 116. The output processing unit 120 outputs the image data generated by the image data generation unit 118, and the printer unit 142 prints out the image data.

The document data and the attribute information of the document data are printed out onto the same original document by the above-described processes. Therefore, by scanning the original document and decoding the two-dimensional code information later, the attribute information of the document data can be acquired in a form of the character information.

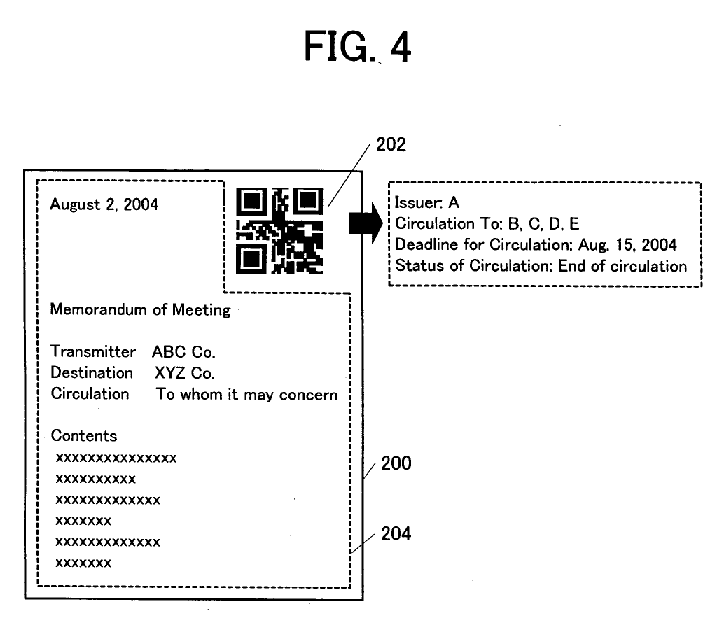

FIG. 4 shows an example of image data printed out by the printer unit 142. Image data 200 includes document data 204 and two-dimensional code information 202, which is generated in accordance with character information indicating an attribute of the document data 204. For example, the two-dimensional code information 202 is formed by converting character information, “Issuer: A/Circulation To: B, C, D, E/Deadline for Circulation: Aug. 15, 2004/Status of Circulation: End of circulation”, into two-dimensional code information.

The first embodiment of the present invention has been described. The above-described first embodiment is an example of the present invention. It is to be understood by those skilled in the art that there are various variations to the combination of each constituent element and each processing process and those variations also fall within the scope of the present invention.

In the above description of the first embodiment, the display unit 140 and the printer unit 142 are not included in the document management device 100. However, the document management device 100 may include the display unit 140 and the printer unit 142. For example, the document management device 100 may be a network MFP having a facsimile function, a printer function, a copying function and a scanner function or the like. For example, the network MFP is a network facsimile machine or a MFP. In this case, the network MFP can establish a connection with a network, such as the Internet and a Public Switched Telephone Network (PSTN). The network MFP carries out communication with a G3 facsimile machine or the like through the PSTN. The network MFP carries out a transmission and a reception of data with another network facsimile machine or an e-mail terminal via the Internet or the like.

Next, a second embodiment of the present invention will be described. A facsimile machine according to the second embodiment includes a function for converting data expressed by character information into two-dimensional code information. Various pieces of information generally known as two-dimensional code information may be used as the two-dimensional code information. For example, a QR code may be used as the two-dimensional code information.

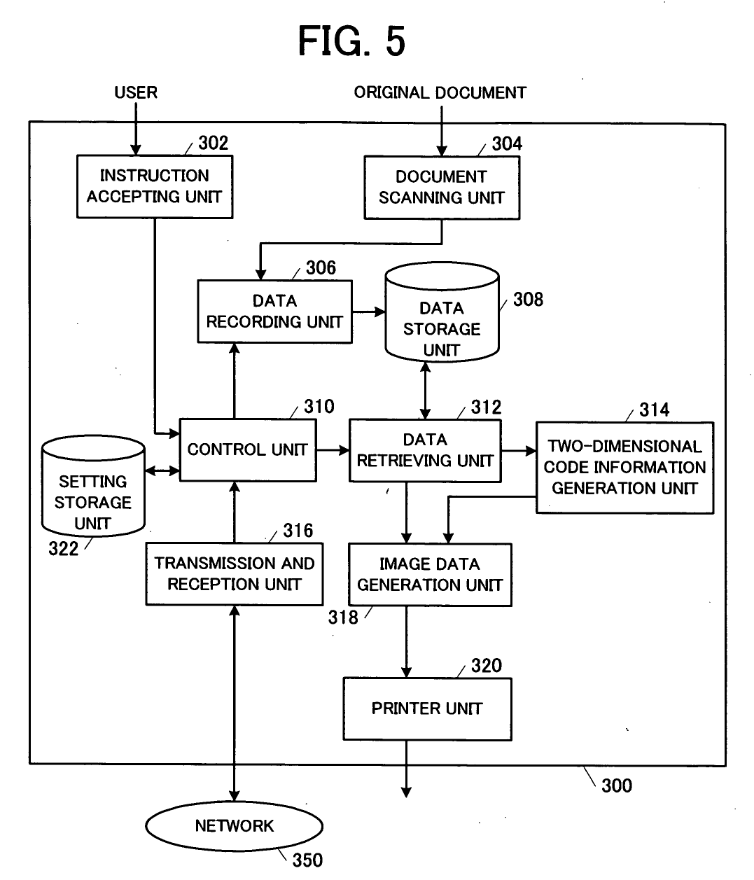

FIG. 5 is a block diagram showing a configuration of a facsimile machine 300 according to the second embodiment of the present invention. The facsimile machine 300 includes an instruction accepting unit 302, a document scanning unit 304, a data recording unit 306, a data storage unit 308, a control unit 310, a data retrieving unit 312, a two-dimensional code information generation unit 314, a transmission and reception unit 316, an image data generation unit 318, a printer unit 320 and a setting storage unit 322.

Each constituent element of the facsimile machine 300 is realized primarily by a CPU of any computer, a memory, a program which realizes the constituent elements shown in FIG. 5 loaded to the memory, a storage unit, such as a hard disk drive which stores the program, and an interface for establishing a connection with a network, by any combination of hardware and software. It is understood by those skilled in the art that various changes and modifications can be made for methods and devices for realizing each of the constituent elements of the facsimile machine 300. Each of the drawings to be described hereinafter shows blocks representing units of function, instead of units of hardware. Further, in FIG. 5, a configuration of a part unrelated to the subject matter of the present invention is omitted.

The transmission and reception unit 316 receives facsimile data from another terminal via a network 350, and transmits facsimile data to another terminal via the network 350. In the second embodiment, for example, the network 350 is the PSTN. The facsimile machine 300 carries out communication with a G3 facsimile machine or the like via the network 350. As another example, the network 350 can be the Internet or the like. In this case, the facsimile machine 300 can also carry out a transmission and a reception of data with another network facsimile machine or an e-mail terminal via the Internet or the like.

The data recording unit 306 stores the facsimile data received by the transmission and reception unit 316 and communication information relating to the facsimile data into the data storage unit 308 by associating with one another. For example, the communication information is header information of the facsimile data. For example, the header information includes a name of a transmitter, a telephone number of the transmitter and a date and time of a reception or the like of the facsimile data.

The data retrieving unit 312 retrieves facsimile data and communication information of the facsimile data from the data storage unit 308.

The two-dimensional code information generation unit 314 converts character information into two-dimensional code information. In the second embodiment, the two-dimensional code information generation unit 314 converts character information indicating the communication information of the facsimile data into two-dimensional code information.

The image data generation unit 318 generates image data including the facsimile data and the two-dimensional code information converted by the two-dimensional code information generation unit 314. The printer unit 320 prints out the image data generated by the image data generation unit 318.

The image data generation unit 318 can include the facsimile data and the two-dimensional code information of the communication information of the facsimile data in image data of one page. By including the facsimile data and the two-dimensional code information in the same page, an extra sheet of paper can be prevented from being wasted when printing out the image data. As another example, the image data generation unit 318 can provide the two-dimensional code information and the facsimile data as image data of different pages.

The image data generation unit 318 can generate image data so that entire facsimile data is included in the image data. However, the image data generation unit 318 can also generate image data in which a part of the facsimile data and the two-dimensional code information are included in two pages. When the facsimile data and the two-dimensional code information are generated as the image data of different pages, the printer unit 320 carries out a processing so that the facsimile data and the two-dimensional code information can be distinguished to be relating to one another. For example, the printer unit 320 sequentially prints out the facsimile data and the two-dimensional code information.

The instruction accepting unit 302 accepts various instructions from the user. The document scanning unit 304 scans an original document of a paper medium or the like, and generates facsimile data in accordance with the scanned original document.

The data recording unit 306 stores the facsimile data generated by the document scanning unit 304 into the data storage unit 308. In this case, the data recording unit 306 can store communication information of the facsimile data by associating with the facsimile data. For example, the communication information includes a name of a transmission destination, a telephone number or the like of the transmission destination, a date and time of a transmission, and a transmission result or the like. When the instruction accepting unit 302 accepts a transmission instruction of the facsimile data, the data recording unit 306 stores the transmission result of the facsimile data by associating with the facsimile data stored in the data storage unit 308.

The control unit 310 controls each of the constituent elements of the facsimile machine 300. The setting storage unit 322 stores a setting regarding whether or not to print out the facsimile data received by the facsimile machine 300, or whether or not to print out the facsimile data received by the facsimile machine 300 and also the communication information of the facsimile data.

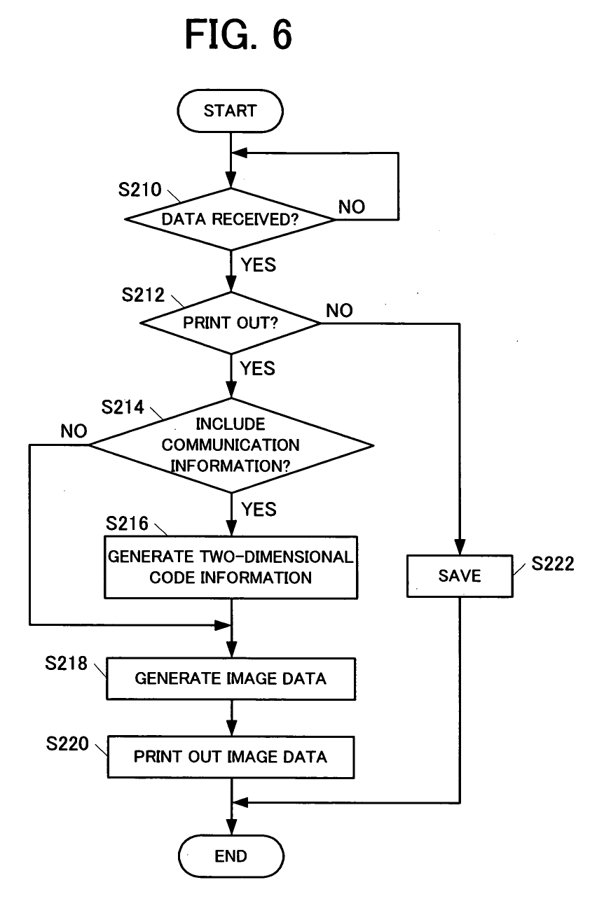

FIG. 6 is a flowchart showing an example of a processing procedure of the facsimile machine 300 according to the second embodiment of the present invention. A description will be made of an example of a processing in which the transmission and reception unit 316 receives facsimile data.

When the transmission and reception unit 316 receives facsimile data (step S210: YES), the control unit 310 determines whether or not to print out the received facsimile data (step S212). The control unit 310 refers to the setting storage unit 322, and determines whether or not to print out the facsimile data received by the transmission and reception unit 316. In accordance with an instruction from the control unit 310, the data recording unit 306 temporarily stores the facsimile data received by the transmission and reception unit 316 along with header information or the like of the received facsimile data into the data storage unit 308.

When printing out the facsimile data (step S212: YES), the control unit 310 determines whether or not to print out the communication information of the facsimile data along with the facsimile data (step S214). The control unit 310 refers to the setting storage unit 322, and determines whether or not to print out the communication information along with the facsimile data.

When printing out the communication information (step S214: YES), in accordance with an instruction from the control unit 310, the data retrieving unit 312 retrieves corresponding facsimile data and the header information or the like from the data storage unit 308. The data retrieving unit 312 transmits the header information to the two-dimensional code information generation unit 314. The two-dimensional code information generation unit 314 converts the header information into two-dimensional code information (step S216).

The image data generation unit 318 embeds the two-dimensional code information generated by the two-dimensional code information generation unit 314 into a margin or the like of the facsimile data retrieved by the data retrieving unit 312 and generates image data (step S218).

The printer unit 320 prints out the image data generated by the image data generation unit 318.

Accordingly, the facsimile data received by the transmission and reception unit 316 is printed out along with the communication information of the facsimile data indicated in the form of the two-dimensional code information. Therefore, a part of the two-dimensional code information of the printed original document can be scanned and decoded later to be converted into character information. Accordingly, the communication information relating to the facsimile data can be acquired in the form of the character information. As a result, a management of the facsimile data can be carried out easily.

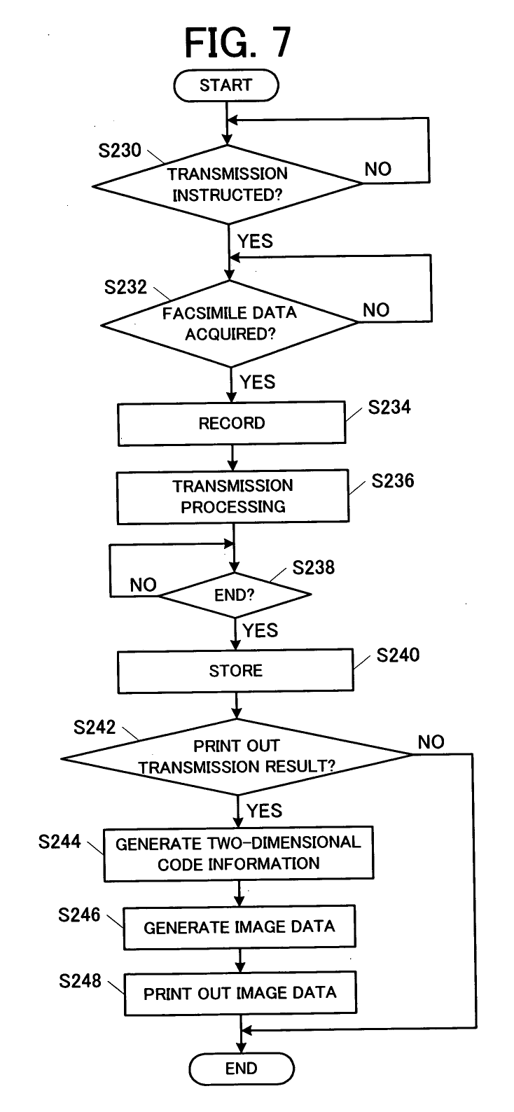

FIG. 7 is a flowchart showing another example of the processing procedure of the facsimile machine 300 according to the second embodiment of the present invention. A description will be made of an example in which an original document scanned by the document scanning unit 304 is transmitted to another terminal via the network 350 in accordance with an instruction from the user.

When the user carries out a transmission instruction of facsimile data (step S230: YES), the control unit 310 determines whether or not facsimile data to be transmitted has been acquired (step S232). The facsimile data can be generated in accordance with the original document scanned by the document scanning unit 304. Alternatively, the facsimile data can be received from another terminal via a private network, such as a Local Area Network (LAN) (not shown). The data recording unit 306 temporarily stores the acquired facsimile data into the data storage unit 308. When the instruction accepting unit 302 accepts a transmission instruction of the facsimile data from the user, the data recording unit 306 stores the transmission instructions into the data storage unit 308 by associating with the facsimile data (step S234). Further, the transmission instruction includes a name of a transmission instruction, a telephone number of the transmission destination, a scheduled date and time of the transmission, and a number of times for retrying the transmission.

In accordance with an instruction from the control unit 310, the transmission and reception unit 316 carries out a processing for transmitting the facsimile data to a predetermined transmission destination (step S236). When the transmission is completed, or when a transmission failure occurs under a prescribed condition, a determination is made to end the transmission (step S238: YES). Then, a transmission result is stored into the data storage unit 308 by being associated with the facsimile data (step S240).

Next, the control unit 310 determines whether or not to print out the transmission result (step S242). The control unit 310 can determine whether or not to print out the transmission result by referring to the setting storage unit 322. The setting storage unit 322 can store a setting regarding whether or not to print out the transmission result by associating with a type of the transmission result, such as a generation of a transmission error. When the control unit 310 determines to print out the transmission result (step S242: YES), the data retrieving unit 312 retrieves a transmission instruction and a transmission result associated with the facsimile data from the data storage unit 308, and transmits to the two-dimensional code information generation unit 314. The two-dimensional code information generation unit 314 converts the transmission instruction and the transmission result into two-dimensional code information (step S244). Next, the data retrieving unit 312 retrieves facsimile data from the data storage unit 308. The image data generation unit 318 embeds the two-dimensional code information generated by the two-dimensional code information generation unit 314 into a margin or the like of the facsimile data and generates image data (step S246).

The printer unit 320 prints out the image data generated by the image data generation unit 318.

Accordingly, the facsimile data transmitted by the transmission and reception unit 316 can be printed out along with the communication information of the facsimile data, which is indicated in the form of the two-dimensional code information. Therefore, a part of the two-dimensional code information of the original document, which is necessary to be retransmitted due to a generation of a transmission error or the like, can be scanned and decoded to be converted into character information. As a result, the communication information relating to the facsimile data can be acquired in the form of the character information. Accordingly, a processing for retransmission can be simplified, and the management of the facsimile data can be carried out easily.

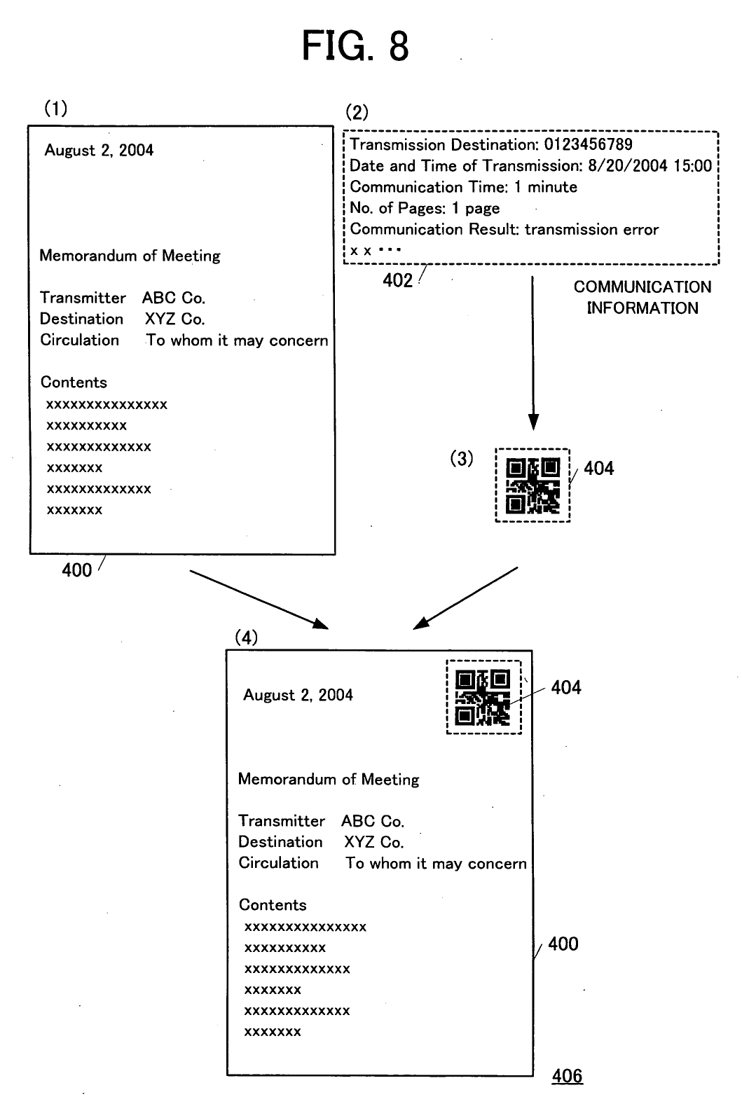

FIG. 8 shows a state in which an original document including facsimile data and two-dimensional code information is printed out in the processing procedure of the facsimile machine 300 described with reference to FIG. 7.

An original document 400 is facsimile data to be transmitted (1). When the user inputs a transmission instruction “Transmission Destination: 0123456789/Date and Time of Transmission: Aug. 20, 2004 15:00/Communication Time: 1 minute/No. of Pages: 1 page” as communication information and the transmission result is an error, character information 402 indicating the communication information is stored into the data storage unit 308 by being associated with the facsimile data 400 (2). The two-dimensional code information generation unit 314 converts the character information indicating the communication information into two-dimensional code information 404 (3). The image data generation unit 318 generates image data including the facsimile data 400 and the two-dimensional code information 404, and the printer unit 320 prints out the image data to output an original document 406 (4).

The second embodiment of the present invention has been described. The above-described second embodiment is an example of the present invention. It is to be understood by those skilled in the art that there are various variations to combination of each constituent element and each processing process and those variations also fall within the scope of the present invention.

Although not shown in the drawings, the facsimile machine 300 can further include a two-dimensional code information decoding unit, which decodes two-dimensional code information and converts into character information. By using a function of the two-dimensional code information decoding unit, the facsimile machine 300 can decode the two-dimensional code information included in the original document printed out from the printer unit 320 and convert into character information. Accordingly, for example, when carrying out a retransmission of facsimile data, communication information such as a transmission destination is not required to be input again. The retransmission processing can be carried out by using the character information acquired by decoding the two-dimensional code information. Moreover, information such as a transmitter of the facsimile data received by the facsimile machine 300 can be acquired in the form of the character information. Therefore, by using the information such as the transmitter of the facsimile data, for example, an address or the like can be registered.

The facsimile machine 300 can be a network MFP having a facsimile function, a printer function, a copying function and a scanner function or the like. For example, the network MFP is a network facsimile machine or MFP.

In the example described with reference to FIG. 7, the image data generation unit 318 generates image data including the facsimile data and the two-dimensional code information, and the printer unit 320 prints out the generated image data. However, the printer unit 320 can be configured to print out the two-dimensional code information in a margin of the original document scanned by the document scanning unit 304. Accordingly, the two-dimensional code information indicating the communication information of an original document can be added to the original document. As a result, the management of the facsimile data can be simplified without using an extra sheet of paper.

Next, a third embodiment of the present invention will be described. A network facsimile machine 500 according to the third embodiment includes a function for converting data indicated by character information into two-dimensional code information. Various pieces of information generally known as two-dimensional code information can be used as the two-dimensional code information. For example, a QR code can be used as the two-dimensional code information.

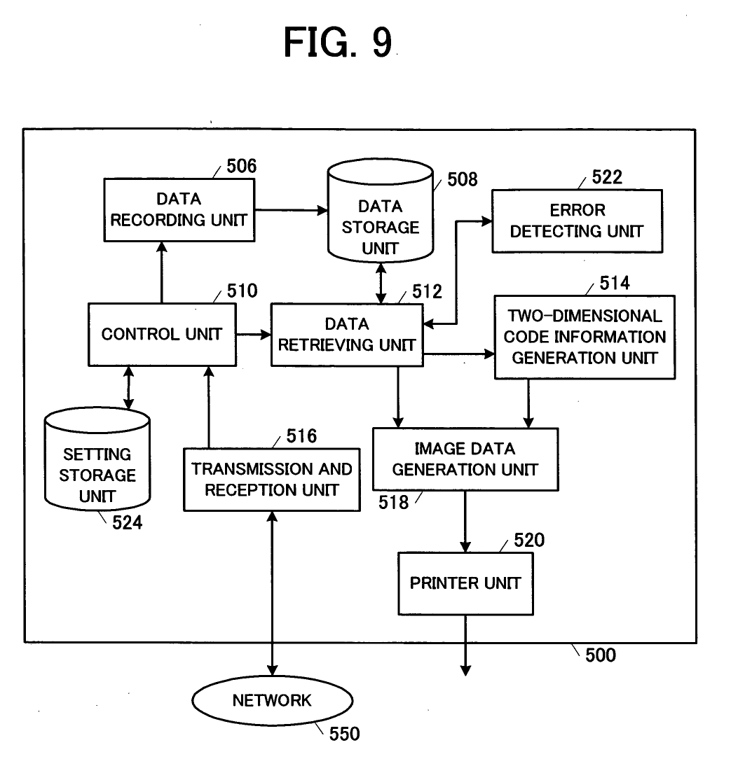

FIG. 9 is a block diagram showing a configuration of the network facsimile machine 500 according to the third embodiment of the present invention. The network facsimile machine 500 includes a data recording unit 506, a data storage unit 508, a control unit 510, a data retrieving unit 512, a two-dimensional code information generation unit 514, a transmission and reception unit 516, an image data generation unit 518, a printer unit 520, an error detecting unit 522 and a setting storage unit 524.

In the third embodiment, the network facsimile machine 500 can be a network MFP having a facsimile function, a printer function, a copying function and a scanner function or the like. For example, the network MFP is a network facsimile machine or MFP.

Each constituent element of the network facsimile machine 500 is realized primarily by a CPU of any computer, a memory, a program which realizes the constituent elements shown in FIG. 9 loaded to the memory, a storage unit such as a hard disk drive which stores the program, and an interface for establishing a connection with a network, by any combination of hardware and software. It is understood by those skilled in the art that various changes and modifications can be made for methods and devices for realizing each of the constituent elements of the network facsimile machine 500. Each of the drawings to be described hereinafter shows blocks representing units of function, instead of units of hardware. Further, in FIG. 9, a configuration of a part unrelated to the subject matter of the present invention is omitted.

The transmission and reception unit 516 receives electronic mail from another terminal and transmits electronic mail to another terminal via a network 550 in accordance with the Simple Mail Transfer Protocol (SMTP) or the Post Office Protocol (POP). In the third embodiment, the network 550 is a public network such as the Internet. The network facsimile machine 500 carries out a transmission and a reception of data with another network facsimile machine or an e-mail terminal via the Internet or the like. In the network facsimile machine 500, facsimile data is generally attached to electronic mail as an attached file. The attached file may be image data of the TIFF or the PDF or the like.

The data recording unit 506 stores electronic mail received by the transmission and reception unit 516 into the data storage unit 508. The data recording unit 506 stores main body information and header information of the electronic mail received by the transmission and reception unit 516 into the data storage unit 508 by associating with the attached file.

The data retrieving unit 512 retrieves the attached file and the main body information and the header information of the electronic mail from the data storage unit 508.

The two-dimensional code information generation unit 514 converts character information into two-dimensional code information. In the third embodiment, the two-dimensional code information generation unit 514 converts the character information of the main body information and the header information or the like of the electronic mail into two-dimensional code information.

The image data generation unit 518 generates image data including at least a part of the attached file and the two-dimensional code information converted by the two-dimensional code information generation unit 514. The printer unit 520 prints out the image data generated by the image data generation unit 518.

The image data generation unit 518 can include the two-dimensional code information in the same page as at least one page of the attached file. The image data generation unit 518 can dispose the two-dimensional code information in a margin of the attached file. Alternatively, the image data generation unit 518 can reduce a size of the attached file to generate a margin, and dispose the two-dimensional code information in the generated margin. By including the two-dimensional code information and a part of the attached file in the same page, an extra sheet of paper can be prevented from being wasted when printing out the image data.

The error detecting unit 522 detects whether or not the attached file of the electronic mail retrieved by the data retrieving unit 512 can be opened, or whether or not the image data has been printed out by the printer unit 520. For example, when the error detecting unit 522 detects that the attached file of the electronic mail retrieved by the data retrieving unit 512 cannot be opened, the two-dimensional code information generation unit 514 can convert character information indicating that the attached file cannot be opened into two-dimensional code information along with the header information and the main body information of the electronic mail. In this case, the image data generation unit 518 generates image data including only the two-dimensional code information, and the printer unit 520 prints out the image data.

When the error detecting unit 522 detects that the image data cannot be printed out by the printer unit 520, the two-dimensional code information generation unit 514 can convert character information indicating that the attached file cannot be printed out into two-dimensional code information along with the header information and the main body information of such electronic mail. In this case, the image data generation unit 518 generates image data including only the two-dimensional code information, and the printer unit 520 outputs the image data.

The control unit 510 controls each constituent element of the network facsimile machine 500. The setting storage unit 524 stores a setting as to whether or not to print out the electronic mail received by the network facsimile machine 500, or whether or not to print out the two-dimensional code information of the header information and the main body information or the like of the electronic mail.

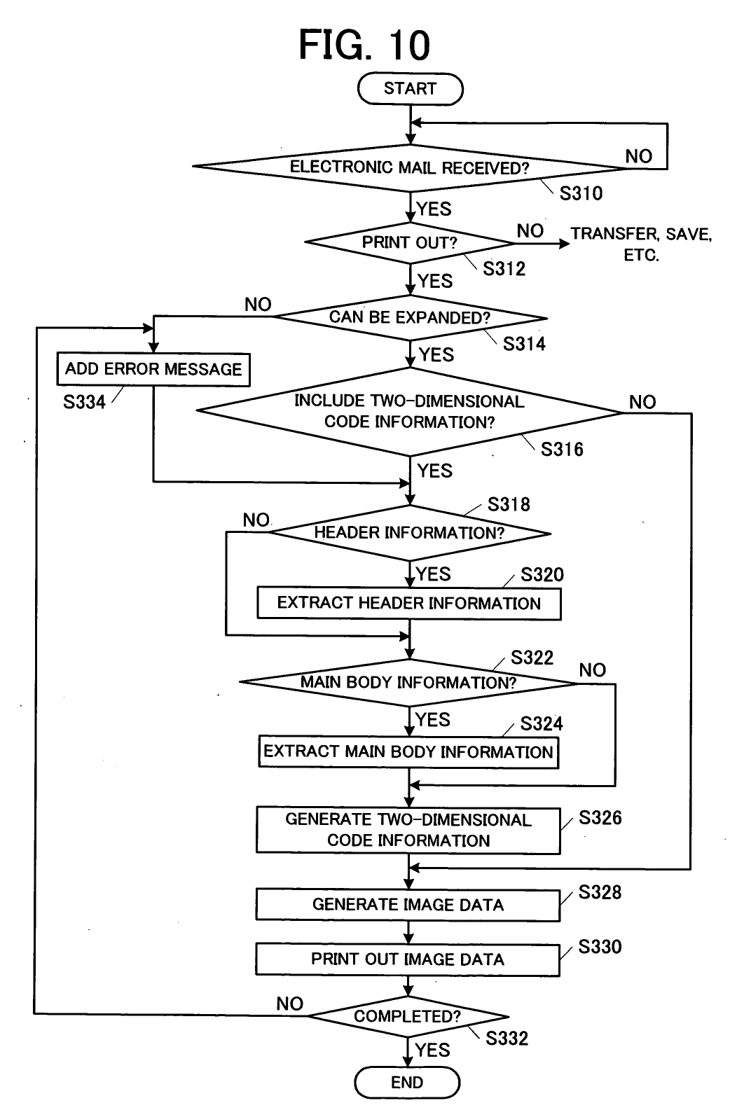

FIG. 10 is a flowchart showing an example of a processing procedure of the network facsimile machine 500 according to the third embodiment of the present invention.

When the transmission and reception unit 516 receives electronic mail (step S310: YES), the control unit 510 determines whether or not to print out the received electronic mail (step S312). The control unit 510 determines whether or not to print out the electronic mail received by the transmission and reception unit 516 by referring to the setting storage unit 524. In accordance with an instruction from the control unit 510, the data recording unit 506 temporarily stores the electronic mail received by the transmission and reception unit 516 into the data storage unit 508. When not printing out the electronic mail (step S312: NO), in accordance with the setting, for example, the network facsimile machine 500 carries out a processing to transfer the electronic mail to another terminal or to save the electronic mail in a prescribed storage unit.

When printing out the electronic mail (step S312: YES), in accordance with an instruction from the control unit 510, the data retrieving unit 512 retrieves an attached file of the electronic mail from the data storage unit 508. The error detecting unit 522 detects whether or not the attached file retrieved by the data retrieving unit 512 can be expanded (step S314). When the attached file can be expanded (step S314: YES), the control unit 510 determines whether or not to print out the two-dimensional code information along with the attached file (step S316). For example, header information and main body information of the electronic mail can be included in the two-dimensional code information. The control unit 510 refers to the setting storage unit 524, and determines whether or not to print out the two-dimensional code information along with the attached file of the electronic mail.

When printing out the two-dimensional code information along with the attached file of the electronic mail (step S316: YES), the control unit 510 determines whether or not to include the header information of the electronic mail in the two-dimensional code information (step S318). When including the header information of the electronic mail in the two-dimensional code information (step S318: YES), the data retrieving unit 512 extracts the header information of the electronic mail in accordance with an instruction of the control unit 510 (step S320). Next, the control unit 510 determines whether or not to include the main body information of the electronic mail in the two-dimensional code information (step S322). When including the main body information of the electronic mail in the two-dimensional code information (step S322: YES), the data retrieving unit 512 extracts the main body information of the electronic mail in accordance with an instruction of the control unit 512 (step S324). When a determination is made at step S318 not to include the header information of the electronic mail (step S318: NO), the process proceeds onto step S322 and the same processing is carried out.

Next, the data retrieving unit 512 transmits the header information and the main body information of the electronic mail extracted at step S320 and step S324 to the two-dimensional code information generation unit 514. The two-dimensional code information generation unit 514 converts the header information and the main body information transmitted from the data retrieving unit 512 into two-dimensional code information (step S326).

The image data generation unit 518 generates image data by disposing the two-dimensional code information generated by the two-dimensional code information generation unit 514 in the margin or the like of, for example, a first page of the attached file of the electronic mail retrieved by the data retrieving unit 512 (step S328).

The printer unit 520 prints out the image data generated by the image data generation unit 518 (step S330).

The error detecting unit 522 detects whether or not the printing of the image data by the printer unit 520 has been completed (step S332). When the printing has been completed (step S332: YES), the process ends.

Meanwhile, when the attached file retrieved by the data retrieving unit 512 cannot be expanded (step S314: NO), the error detecting unit 522 adds character information of an error message indicating that the attached file failed to be opened (step S334). According to necessity, the character information of the error message is converted into two-dimensional code information by the two-dimensional code information generation unit 514 along with the header information and the main body information of the electronic mail (steps S318 through S326). The image data generation unit 518 generates image data including only two-dimensional code information (step S328). The printer unit 520 prints out the image data (step S330).

When the printing of the image data fails to be completed due to some circumstances (step S332: NO), the process returns to step S334. The error detecting unit 522 adds character information of an error message indicating that the image data failed to be printed out (step S334). According to necessity, the character information of the error message is converted into two-dimensional code information by the two-dimensional code information generation unit 514 along with the header information and the main body information of the electronic mail (steps S318 through S326). Then, the image data generation unit 518 generates image data including only the two-dimensional code information (step S328). The printer unit 520 prints out the image data (step S330).

Accordingly, along with the attached file of the electronic mail received by the transmission and reception unit 516, the two-dimensional code information of the character information other than the attached file is printed out. Therefore, a part of the two-dimensional code information of the printed original document can be scanned and decoded to be converted into character information later. Accordingly, the header information and the main body information or the like included in the electronic mail can be acquired in the form of the character information. As a result, the management of the data acquired by the network facsimile machine 500 carried out after the data is printed out can be facilitated.

The two-dimensional code information can include a large volume of information in a small area. Therefore, when printing out the attached file, the two-dimensional code information of the header information and the main body information or the like can be included in the margin or the like of the attached file and printed out. As a result, a paper resource can be saved.

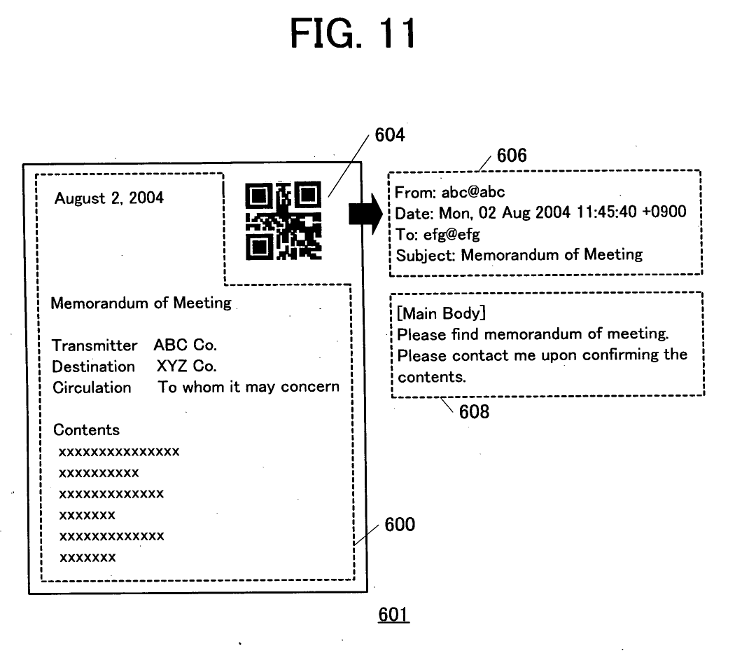

FIG. 11 shows a state in which an original document including an attached file and two-dimensional code information is printed out in the processing procedure of the network facsimile machine 500 described with reference to FIG. 10.

An original document 601 includes an image 600 of the attached file and two-dimensional code information 604, which is printed in the margin of the original document 601. The two-dimensional code information 604 is formed by converting header information 606 and main body information 608 of the electronic mail, which are indicated in the form of character information, into two-dimensional code information. For example, the header information 606 includes an address of a transmitter, a date and time of a transmission, an address of a transmission destination and a subject. The main body information 608 includes a comment such as “Please find memorandum of meeting. Please contact me upon confirming the contents”.

As described above, by associating the header information and the main body information of the electronic mail with the attached file of the electronic mail and printing out, the management of the attached file can be carried out easily later. By converting the header information and the main body information or the like of the electronic mail into two-dimensional code information and printing out, an area for printing out the two-dimensional code information can be reduced. Accordingly, the header information and the main body information of the electronic mail are not required to be printed out onto separate paper from the attached file. As a result, an extra sheet of paper is not wasted. Moreover, since the attached file and the header information and the main body information or the like of the electronic mail are printed on the same paper, the management can be facilitated even more. Furthermore, by scanning and decoding the two-dimensional code information, the header information and the main body information of the electronic mail can be acquired in the form of the character information again. As a result, a sorting of documents can be carried out easily.

The third embodiment of the present invention has been described. The above-described third embodiment is an example of the present invention. It is to be understood by those skilled in the art that there are various variations to combination of each constituent element and each processing process and those variations also fall within the scope of the present invention.

Although not shown in the drawings, the network facsimile machine 500 can further include a two-dimensional code information decoding unit, which decodes the two-dimensional code information and converts into character information. By using a function of the two-dimensional code information decoding unit, the network facsimile machine 500 can decode the two-dimensional code information included in the original document printed out from the printer unit 520 and convert into the character information.

1. A document management device, comprising:
a conversion unit, which converts character information indicating an attribute of document data into two-dimensional code information of a prescribed format;
an image data generation unit, which generates image data including the document data and the two-dimensional code information; and
an output unit, which outputs the image data.

2. The document management device according to claim 1, further comprising an input accepting unit, which accepts an input of the character information indicating the attribute of the document data,
wherein the conversion unit converts the character information accepted by the input accepting unit into the two-dimensional code information of the prescribed format.

3. The document management device according to claim 1, further comprising a storage unit, which stores the character information indicating the attribute of the document data by associating with the document data,
wherein the conversion unit converts the character information associated with the document data into the two-dimensional code information of the prescribed format.

4. The document management device according to claim 3, further comprising an instruction accepting unit, which accepts an output instruction of the document data and accepts a selection of an attribute to be included in the two-dimensional code information of the prescribed format from the attribute stored by being associated with the document data,
wherein the conversion unit converts the character information indicating the attribute accepted by the instruction accepting unit into the two-dimensional code information of the prescribed format.

5. The document management device according to claim 1, further comprising a setting storage unit, which stores a setting of an attribute to be included in the two-dimensional code information of the prescribed format,
wherein the conversion unit refers to the setting storage unit, selects an attribute to be included in the two-dimensional code information of the prescribed format, and converts the character information indicating the attribute into the two-dimensional code information of the prescribed format.

6. The document management device according to claim 1, further comprising an event storage unit, which stores character information indicating an event to be a trigger for outputting the document data,
wherein the conversion unit converts the character information indicating the event into the two-dimensional code information of the prescribed format as the character information indicating the attribute of the document data when the event generates.

7. A facsimile machine, comprising:
a reception unit, which receives facsimile data,
a conversion unit, which converts communication information relating to the facsimile data received by the reception unit into two-dimensional code information of a prescribed format; and
a printer unit, which simultaneously prints out the facsimile data received by the reception unit and the two-dimensional code information of the communication information relating to the facsimile data.

8. The facsimile machine according to claim 7, further comprising an image data generation unit, which generates image data including the facsimile data received by the reception unit and the two-dimensional code information of the communication information relating to the facsimile data,
wherein the printer unit prints out the image data.

9. The facsimile machine according to claim 7, wherein the reception unit receives the communication information relating to the facsimile data as header information indicated by character information, and the conversion unit converts the header information into two-dimensional code information.

10. The facsimile machine according to claim 7, further comprising:
an instruction accepting unit, which accepts a transmission instruction of the facsimile data; and
a transmission unit, which transmits the facsimile data in accordance with a transmission instruction of the facsimile data accepted by the instruction accepting unit;
wherein the conversion unit converts the communication information relating to facsimile data, which the transmission instruction has been accepted by the instruction accepting unit, into the two-dimensional code information of the prescribed format, and
the printer unit simultaneously prints out the facsimile data, which the transmission instruction has been accepted by the instruction accepting unit, and the two-dimensional code information of the communication information relating to the facsimile data.

11. The facsimile machine according to claim 10, further comprising a decoding unit, which decodes the two-dimensional code information of the prescribed format,
wherein the instruction accepting unit accepts the transmission instruction of the facsimile data in a form of the two-dimensional code information of the prescribed format, and
the transmission unit transmits the facsimile data in accordance with the transmission instruction decoded by the decoding unit.

12. A facsimile machine, comprising:
an instruction accepting unit, which accepts a transmission instruction of facsimile data;
a transmission unit, which transmits the facsimile data in accordance with the transmission instruction of the facsimile data accepted by the instruction accepting unit;
a conversion unit, which converts communication information relating to the facsimile data, which the transmission instruction has been accepted by the instruction accepting unit, into two-dimensional code information of a prescribed format; and
a printer unit, which simultaneously prints out at least a part of the facsimile data, which the transmission instruction has been accepted by the instruction accepting unit, and the two-dimensional code information of the communication information relating to the facsimile data.

13. The facsimile machine according to claim 12, further comprising an image data generation unit, which generates image data including at least the part of the facsimile data, which the transmission instruction has been accepted by the instruction accepting unit, and the two-dimensional code information of the communication information relating to the facsimile data;
wherein the printer unit prints out the image data.

14. The facsimile machine according to claim 12, wherein the conversion unit converts the transmission instruction accepted by the instruction accepting unit into two-dimensional code information as the communication information relating to the facsimile data.

15. The facsimile machine according to claim 12, further comprising a transmission result acquiring unit, which acquires a transmission result of the facsimile data transmitted by the transmission unit,
wherein the conversion unit converts the transmission result acquired by the transmission result acquiring unit into two-dimensional code information as the communication information relating to the facsimile data.

16. The facsimile machine according to claim 12, further comprising a decoding unit, which decodes the two-dimensional code information of the prescribed format,
wherein the instruction accepting unit accepts the transmission instruction of the facsimile data in a form of the two-dimensional code information of the prescribed format, and
the transmission unit transmits the facsimile data in accordance with the transmission instruction decoded by the decoding unit.

17. A network facsimile machine, comprising:
a reception unit, which receives electronic mail including an attached file;
a conversion unit, which converts at least a part of character information of the electronic mail other than the attached file into two-dimensional code information of a prescribed format; and
a printer unit, which prints out at least the part of the attached file along with the two-dimensional code information converted by the conversion unit.

18. The network facsimile machine according to claim 17, wherein the conversion unit converts header information of the electronic mail into two-dimensional code information of the prescribed format.

19. The network facsimile machine according to claim 17, wherein the conversion unit converts main body information of the electronic mail into the two-dimensional code information of the prescribed format.

20. The network facsimile machine according to claim 17, further comprising an image data generation unit, which generates image data including at least the part of the attached file and the two-dimensional code information converted by the conversion unit,
wherein the printer unit prints out the image data.

21. The network facsimile machine according to claim 17, further comprising a determination unit, which determines whether or not the printer unit can print out the attached file,
wherein when the determination unit determines that the printer unit cannot print out the attached file, the conversion unit converts information indicating that the attached file cannot be printed out into the two-dimensional code information of the prescribed format along with the at least the part of the character information of the electronic mail other than the attached file, and
the printer unit prints out the two-dimensional code information.

22. A computer readable recording medium recording a document management program for functioning a computer as a conversion unit, which converts character information indicating an attribute of document data into two-dimensional code information of a prescribed format, an image data generation unit, which generates image data including the document data and the two-dimensional code information, and an output control unit, which outputs the image data by an output unit.

23. A document management method for a computer to convert character information indicating an attribute of document data into two-dimensional code information of a prescribed format, to generate image data including the document data and the two-dimensional code information, and to output the image data.
